(19) United States
(12) Patent Application Publication
(10) Pub. No.: US 2005/0002442 A1
(43) Pub. Date: Jan. 6, 2005

(54) Method and apparatus for detection of Pilot signal with frequency offset using multi-stage correlator

(76) Inventors: Louis Robert Litwin, Plainsboro, NJ (US); Alton Shelborne Keel, Melbourne, FL (US); Wen Gao, Plainsboro, NJ (US)

Correspondence Address: THOMSON MULTIMEDIA LICENSING INC;JOSEPH S TRIPOLI, PO BOX 5312, 2 INDEPENDENCE WAY, PRINCETON, NJ, 08543-5312, US

(21) Appl. No.: 10/612,311

(22) Filed: Jul. 2, 2003

(51) Int. Cl. H04B 1/707

(52) U.S. Cl. 375/142; 375/150; 375/148

(57) ABSTRACT

The disclosed embodiments relate to a method and apparatus for performing a pilot synchronization operation in a wireless communication system. The system may contain a plurality of sliding correlators that each receives a portion of a received correlation sequence and provides a partial correlation output. An absolute value block may take the absolute value of each partial correlation output. Circuitry may combine the absolute values of each of the partial correlation outputs to form a correlation output.

### FIELD OF THE INVENTION

The present invention relates to processing of received code division multiple access (“CDMA”) signals.

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Manufacturers of wireless communication devices have a wide range of transmission technologies to choose from when designing wireless systems. Some exemplary technologies include time division multiple access (“TDMA”), code division multiple access (“CDMA”) and the like. CDMA, which is typically implemented using direct sequence spread spectrum technology, is very popular in communications systems, including cellular telephones and the like.

In a CDMA system, a code or symbol is assigned to all speech bits in a voice or data signal. The symbols are encoded across a frequency spectrum and transmitted to a receiver. When the encoded CDMA symbols are received, they are decoded and reassembled into a signal representative of the original voice signal.

In processing received CDMA signals, it may be difficult to detect long symbols in the presence of a frequency offset. Because the chips (each chip is equal to one bit in a spreading code) that make up a symbol may tend to rotate in the presence of a frequency offset, it is possible for the chips to rotate completely around the complex plane during the integration period of one symbol. When this happens, the chips may destructively combine to produce a very small correlation peak. One method may be to solve this problem may be to implement a frequency synchronization block in hardware, but such solutions may be undesirably expensive in order to be able to tolerate higher frequency offsets. Absent more expensive hardware solutions, a receiver may only be able to detect long symbols in the presence of relatively low frequency offsets. An improved method and apparatus for the detection of long symbols in the presence of a relatively high frequency offset is desirable.

### SUMMARY OF THE INVENTION

The disclosed embodiments relate to a method and apparatus for performing a pilot synchronization operation in a wireless communication system. The system may contain a plurality of sliding correlators that each receives a portion of a received correlation sequence and provides a partial correlation output. An absolute value block may take the absolute value of each partial correlation output. Circuitry may combine the absolute values of each of the partial correlation outputs to form a correlation output.

### BRIEF DESCRIPTION OF THE DRAWINGS

In the drawings:

FIG. 1 is a block diagram of an exemplary CDMA receiver in which embodiments of the present invention may be employed; and

FIG. 2 is a diagram illustrating a cell search block according to an embodiment of the present invention.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

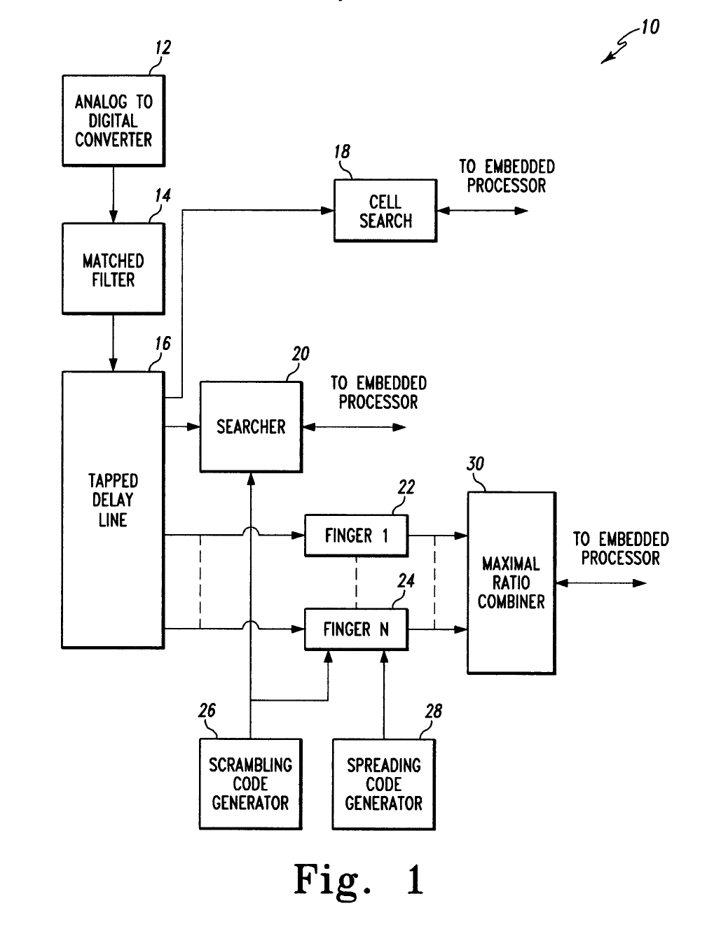

FIG. 1 is a block diagram of an exemplary CDMA receiver in which embodiments of the present invention may be employed. The CDMA receiver is generally referred to by the reference numeral 10. After an analog CDMA signal is received, it is converted to a digital signal by an analog-to-digital converter 12. The digital output of the analog-to-digital converter 12 is delivered to a matched filter 14. The matched filter 14 has a response that is matched to the transmit pulse shaping filter and the matched filter 14 is used to filter the output of the analog-to-digital converter 12.

The output of the matched filter 14 is delivered to a tapped delay line 16, which provides output to various receiver components. The various taps of the tapped delay line 16 may be adjusted to synchronize the operation of the CDMA receiver 10.

One output from the tapped delay line 16 is delivered to a cell search block 18. The cell search block may be implemented in receivers that comply with third generation (“3G”) wireless communication standards such as the Universal Mobile Telecommunications System (“UMTS”) Wideband Code Division Multiple Access (“WCDMA”) standard, which is hereby incorporated by reference, to synchronize a mobile terminal such as a cellular telephone with a base station. The cell search block 18 may perform synchronization when a user's phone is first turned on or when synchronization with the base station is lost (for example, after going through a tunnel).

In the UMTS WCDMA standard, both the Primary Synchronization Channel (“SCH”) and Common Pilot Channel (“CPICH”) have a symbol length of 256 chips. The Primary SCH channel is a sparse channel and it only contains data during the first 256 chips of each 2560 chip slot. The same data is repeated for every slot in the frame and all frames carry the same Primary SCH channel. In addition, all cells in a WCDMA system transmit identical Primary SCH channels. Once the Primary SCH channel is acquired by a mobile terminal, the receiver will have achieved chip, symbol and slot synchronization. However, since the Primary SCH contains the same data in every slot, it cannot be used to achieve frame synchronization because all slots in a frame are identical and hence they cannot be used to determine the location of the frame start.

The Secondary SCH channel is different for every cell in a UMTS system and its purpose is to aid the receiver in obtaining frame synchronization as well as knowledge of the scrambling code group used in the current cell. Like the Primary SCH channel, the Secondary SCH channel is also only transmitted during the first 256 chips of each slot. Each slot of a frame contains a Secondary Synchronization Code (“SSC”). There are a total of 16 possible SSCs. These SSCs are complex-valued and they are based on Hadamard sequences.

The CPICH is a continuous downlink pilot signal that contains a known training sequence scrambled by the current cell's scrambling code. The training sequence used is a constant 1+j. Unlike the SCH channel, the CPICH is a continuous signal that is transmitted for the entire duration of each frame. Once the correct scrambling code group is determined, the receiver can correlate against the CPICH using each of the eight different scrambling codes in a given code group in order to find the correct scrambling code for the current cell.

The cell search block 18 performs at least two functions. First, it acquires the Primary SCH channel to achieve slot synchronization. A UMTS frame (with duration of 10 ms) consists of 38400 chips. The frame is made up of 15 slots, each of 2560 chips in length. After the cell search block 18 acquires slot synchronization, the CDMA receiver 10 has knowledge of slot boundaries, but it still does not know when frames start. Second, the cell search block 18 then acquires the Secondary SCH channel in order to achieve frame synchronization.

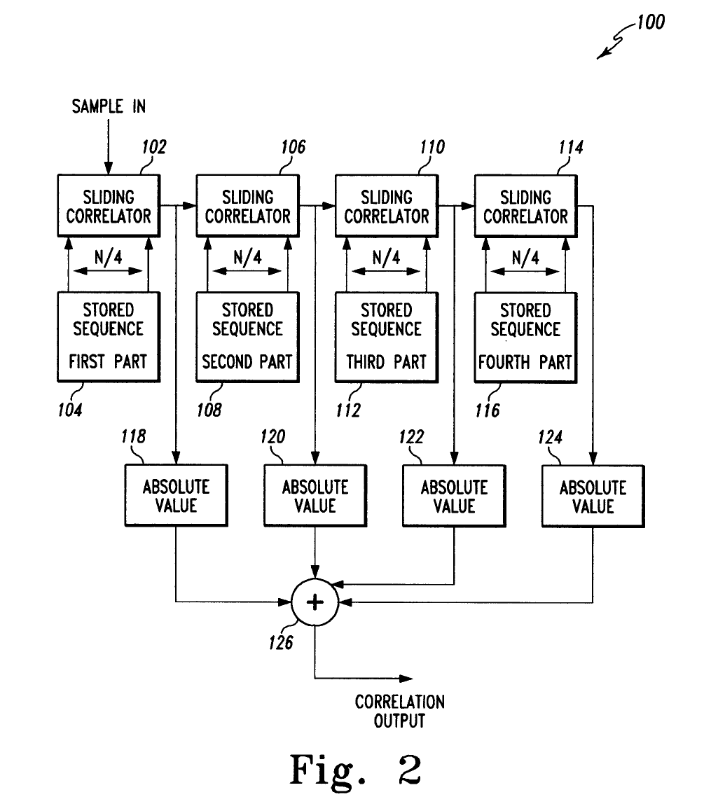

Simultaneously, the acquisition of the Secondary SCH channel uniquely determines which downlink scrambling code group is being transmitted. Each code group contains eight possible scrambling codes and the block correlates against each one to determine which one has the highest peak (and hence the most likelihood of being transmitted). Once determined, other blocks in the CDMA receiver 10 can tune to the base station by using this scrambling code. The operation of the cell search block 18 is described in greater detail below with reference to FIG. 2.

The tapped delay line 16 delivers a second output to a searcher block 20. A scrambling code generator 26 also delivers a signal to the searcher block 20. The searcher block 20 correlates the received samples against different delayed versions of the scrambling code. By monitoring the correlation outputs at different offsets of the scrambling code, the block searches for peaks which represent multipath signals from which the receiver can receive data.

A plurality of N finger circuits 22, 24 may be included in the CDMA receiver 10. The finger circuits 22, 24 may receive input from the tapped delay line 16, the scrambling code generator 26 and a spreading code generator 28. In a spread-spectrum CDMA system such as required by UMTS, data bits are used to modulate spreading codes of different lengths. If a bit is modulated onto a spreading code of length 256, the data rate will be low (because it takes 256 chips to send a bit) but the processing gain will be high (because of the correlation gain from correlating against a sequence of length 256). If a bit is modulated onto a spreading code of length four, the data rate will be high (because a bit can be sent every four chips) but the processing gain will be low (since there is not much correlation gain from correlating against a short four-chip sequence).

Each of the finger circuits 22, 24 may be dropped onto a peak found by the searcher block 20. Each of the finger circuits 22, 24 may contain a correlator that correlates the received samples against the scrambling code. The finger circuits 22, 24 may despread the data.

The output of the finger circuits 22, 24 is delivered to a maximal ratio combiner (“MRC”) 30. The MRC 30 takes the samples from each finger (which corresponds to different multipath versions of the same downlink transmitted signal), rotates them by their pilots to align the phase of the signals and adds them together to form the estimate of the transmitted symbols that will be processed by the CDMA receiver 10.

The outputs of the cell search block 18, the searcher block 20 and the MRC 30 may be delivered to an embedded processor (not shown) for further processing. As set forth above, FIG. 2 further illustrates the operation of the cell search block 18.

FIG. 2 is a diagram illustrating a cell search block according to an embodiment of the present invention. The cell search block circuit is generally referred to by the reference numeral 100. For purposes of illustration, the assumption is made that the cell search block is attempting to correlate against a stored sample sequence comprising N samples.

In cases where the symbol period is long and frequency offsets are large, the cell search block circuit 100 may improve the ability of a mobile CDMA receiver to synchronize with a base station by identifying pilot channels in the received CDMA data. The cell search block circuit 100 operates by breaking the correlation down into several shorter correlations and then non-coherently combining the outputs of the shorter correlations by summing the absolute values of the correlation outputs. When in the presence of a larger frequency offset (e.g., 10 kHz), the pilot channels such as the Primary SCH channel and the Secondary SCH channel are very difficult to detect using normal correlations. However, embodiments of the present invention may be employed to easily acquire the pilot channels.

By dividing the correlation period into N shorter periods, the chips will not rotate as much during the correlation interval and this will prevent the chips from being destructively combined. The sum of the absolute values will thus form a stronger correlation peak than a normal correlation would when in the presence of a frequency offset.

A sample input is received by a sliding correlator 102. Portions of the received sample are delivered to additional sliding correlators 106, 110 and 114. For purposes of example, four sliding correlators are illustrated in FIG. 2. Those of ordinary skill in the art will appreciate that it is possible to use more or less sliding correlator stages. The number of sliding correlator stages employed depends on the degree of the frequency offset that is expected. A larger frequency offset may require more stages.

The sliding correlator 102 attempts to correlate the N/4 sample that it receives with a stored sequence 104 corresponding to the first part of a target sequence. Similarly, the sliding correlator 106 correlates the N/4 sample that it receives with a stored sequence 108 corresponding to the second part of a target sequence. The sliding correlators 110 and 114 respectively correlate the N/4 samples that they receive with a stored sequence 112 (which corresponds to the third part of the target sequence) and a stored sequence 116 (which corresponds to the fourth part of the target sequence).

The outputs of the sliding correlators 102, 106, 110 and 114, which may be referred to as partial correlation outputs, are respectively delivered to absolute value blocks 118, 120, 122 and 124. The outputs of the absolute value blocks 118, 120, 122 and 124 are delivered to a summing circuit 126, which combines them into a correlation output. The present invention results in a correlation output having correlation peaks that facilitate recognition of pilot channels such as the Primary SCH and Secondary SCH pilot channels. When the pilot channels have been identified, the timing of the receiver 10 may be altered to facilitate accurate processing of received signals.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. An apparatus for performing a pilot synchronization operation in a wireless communication system, the apparatus comprising:
a plurality of sliding correlators that each receives a portion of a received correlation sequence and provides a partial correlation output;
an absolute value block that takes the absolute value of each partial correlation output; and
circuitry that combines the absolute values of each of the partial correlation outputs to form a correlation output.

2. The apparatus set forth in claim 1, wherein each of the plurality of sliding correlators receives a portion of a stored correlation sequence for comparison to the portion of the received correlation sequence.

3. The apparatus set forth in claim 1, wherein the correlation output comprises a correlation peak.

4. The apparatus set forth in claim 3, wherein the correlation peak corresponds to a Primary SCH channel.

5. The apparatus set forth in claim 3, wherein the correlation peak corresponds to a Secondary SCH channel.

6. The apparatus set forth in claim 1, wherein the apparatus comprises a portion of a code division multiple access receiver.

7. The apparatus set forth in claim 1, wherein the apparatus comprises a portion of a receiver that complies with the Universal Mobile Telecommunications System (“UMTS”) Wideband Code Division Multiple Access (“WCDMA”) standard.

8. The apparatus set forth in claim 1, wherein the apparatus comprises at least a portion of a cell search block.

9. A code division multiple access (“CDMA”) receiver, comprising:
an analog-to-digital converter that receives a CDMA signal and converts the CDMA signal into a digital signal:
a matched filter that filters the digital signal to produce a filtered digital signal;
a tapped delay line that receives the filtered digital signal and produces a delayed filtered digital signal; and
a cell search block, comprising:
a plurality of sliding correlators that each receives at least a portion of the delayed filtered digital signal and provides a partial correlation output;
an absolute value block that takes the absolute value of each partial correlation output; and
circuitry that combines the absolute values of each of the partial correlation outputs to form a correlation output.

10. The CDMA receiver set forth in claim 9, wherein each of the plurality of sliding correlators receives a portion of a stored correlation sequence for comparison to the portion of the received correlation sequence.

11. The CDMA receiver set forth in claim 9, wherein the correlation output comprises a correlation peak.

12. The CDMA receiver set forth in claim 11, wherein the correlation peak corresponds to a Primary SCH channel.

13. The CDMA receiver set forth in claim 11, wherein the correlation peak corresponds to a Secondary SCH channel.

14. The CDMA receiver set forth in claim 9, wherein the apparatus comprises a portion of a code division multiple access receiver.

15. The CDMA receiver set forth in claim 9, wherein the CDMA receiver complies with the Universal Mobile Telecommunications System (“UMTS”) Wideband Code Division Multiple Access (“WCDMA”) standard.

16. A method for forming a correlation output in a wireless communication system, the method comprising:
receiving a correlation sequence to produce a received correlation sequence;
segmenting the received correlation sequence into a plurality of partial correlation sequences;
comparing each partial correlation sequence to a portion of a stored correlation sequence;
producing a partial correlation output based on the comparison of each partial correlation sequence to the corresponding stored correlation sequence;
determining the absolute value of each partial correlation output; and
combining the absolute values of each of the partial correlation outputs to form a correlation output.

17. The method set forth in claim 16, comprising identifying a correlation peak in the correlation output.

18. The method set forth in claim 17, comprising identifying a Primary SCH channel based on the correlation peak.

19. The method set forth in claim 17, comprising identifying a Secondary SCH channel based on the correlation peak.

20. The method set forth in claim 16, wherein the recited acts are performed in the recited order.
